(19) United States
(12) Patent Application Publication
(10) Pub. No.: US 2024/0332497 A1
(43) Pub. Date: Oct. 3, 2024

(54) SECONDARY BATTERY SYSTEM

(71) Applicant: TOYOTA JIDOSHA KABUSHIKI KAISHA, Toyota-shi (JP)

(72) Inventor: Kazushige NOMOTO, Sunto-gun (JP)

(73) Assignee: TOYOTA JIDOSHA KABUSHIKI KAISHA, Toyota-shi (JP)

(21) Appl. No.: 18/418,717

(22) Filed: Jan. 22, 2024

(30) Foreign Application Priority Data
Mar. 31, 2023 (JP) 2023-058833

(51) Int. Cl. H01M 4/131; H01M 4/02; H01M 4/505; H01M 4/525; H01M 4/60; H01M 10/0562; H01M 10/44

(52) U.S. Cl. CPC H01M 4/131; H01M 4/505; H01M 4/525; H01M 4/602; H01M 10/0562; H01M 10/448; H01M 2004/027; H01M 2300/0068

(57) ABSTRACT

A secondary battery system of the present disclosure includes a secondary battery and a control unit. The secondary battery includes a cathode active material layer, an electrolyte layer, and an anode active material layer. The cathode active material layer includes a cathode active material, a sulfide solid electrolyte, and a fluorine-based liquid material. The control unit controls charging of the secondary battery such that a cathode potential at a charging termination potential of the secondary battery is equal to or greater than 4.3 V (vs. Li/Li+).

### CROSS-REFERENCE TO RELATED APPLICATION

This application claims priority to Japanese Patent Application No. 2023-058833 filed on Mar. 31, 2023 incorporated herein by reference in its entirety.

### BACKGROUND

### 1. Technical Field

The present application discloses a secondary battery system.

### 2. Description of Related Art

Japanese Unexamined Patent Application Publication No. 2019-125510 (JP 2019-125510 A) discloses use of a sulfide solid electrolyte together with a cathode active material in a cathode active material layer of a secondary battery.

### SUMMARY

In the related-art secondary battery, the resistance is likely to increase in a high-voltage region (e.g., 4.3 V (vs. Li/Li+) or more).

The present application discloses the following aspects as means for solving the above problem.

### First Aspect

A secondary battery system includes: a secondary battery; and a control unit. The secondary battery includes a cathode active material layer, an electrolyte layer, and an anode active material layer. The cathode active material layer includes a cathode active material, a sulfide solid electrolyte, and a fluorine-based liquid material. The control unit is configured to control charging of the secondary battery to cause a cathode potential at a charging end potential of the secondary battery to be equal to or higher than 4.3 V (vs. Li/Li+).

### Second Aspect

In the secondary battery system according to the first aspect, the cathode active material layer may include perfluoropolyether as the fluorine-based liquid material.

### Third Aspect

In the secondary battery system according to the first or second aspect, the cathode active material may be a Li containing oxide.

### Fourth Aspect

In the secondary battery system according to the third aspect, the Li containing oxide may include at least one kind of transition metal element among Mn, Ni, and Co as a constituent element.

According to the secondary battery system of the present disclosure, the increase in the resistance of the secondary battery in the high-voltage region is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a configuration of a secondary battery system.

### DETAILED DESCRIPTION OF EMBODIMENTS

Hereinafter, an embodiment of a secondary battery system of the present disclosure will be described. However, the secondary battery system of the present disclosure is not limited to the embodiments described below.

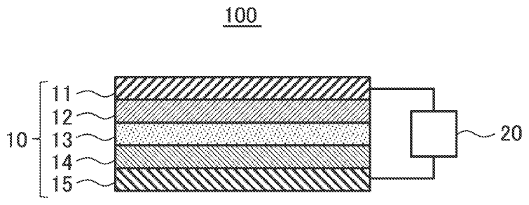

As illustrated in FIG. 1, a secondary battery system 100 according to an embodiment includes a secondary battery 10 and a control unit 20. The secondary battery 10 includes a cathode active material layer 12, an electrolyte layer 13, and an anode active material layer 14. The cathode active material layer 12 includes a cathode active material, a sulfide solid electrolyte, and a fluorine-based liquid material. The control unit 20 controls charging of the secondary battery 10 such that the cathode potential at the charge termination potential of the secondary battery 10 is equal to or higher than 4.3 V (vs. Li/Li+).

### 1. Secondary Battery

The secondary battery 10 includes a cathode active material layer 12, an electrolyte layer 13, and an anode active material layer 14. As shown in FIG. 1, the secondary battery 10 may include a positive electrode current collector 11 in contact with the cathode active material layer 12. The secondary battery 10 may include a negative electrode current collector 15 in contact with the anode active material layer 14.

### 1.1 Cathode Active Material Layer

The cathode active material layer 12 includes a cathode active material, a sulfide solid electrolyte, and a fluorine-based liquid material. The cathode active material layer 12 may optionally contain a conductive auxiliary agent or a binder. The cathode active material layer 12 may optionally contain other electrolytes. The content of each component in the cathode active material layer 12 may be appropriately determined according to the desired battery performance. For example, the cathode active material layer 12 may contain a fluorine-based liquid material in an amount of 1% by volume or more and 25% by volume or less. The content of the fluorine-based liquid material contained in the cathode active material layer 12 may be, for example, 1% by volume or more, 3% by volume or more, 5% by volume or more, 7% by volume or more, 8% by volume or more, 9% by volume or more, 10% by volume or more, 11% by volume or more, or 12% by volume or more. The content of the fluorine-based liquid material contained in the cathode active material layer 12 may be, for example, 25% by volume or less, 24% by volume or less, 22% by volume or less, 20% by volume or less, 18% by volume or less, 16% by volume or less, 14% by volume or less, or 12% by volume or less. The volume ratio of the fluorine-based liquid material in the cathode active material layer 12 can be measured, for example, as follows. That is, the volume of the cathode active material layers 12 is measured in advance using an optical microscope or a SEM. The volume of the fluorine-based liquid material contained in the cathode active material layer 12 may be specified by washing the cathode active material layer 12 with a solvent (one that can dissolve the fluorine-based liquid material and does not dissolve the other electrode material), recovering the filtrate in which the fluorine-based liquid material is dissolved by suction filtration or the like, and analyzing the recovered solvent with a GC-MS. In addition, the volume of the fluorine-based liquid material contained in the cathode active material layer 12 may be directly measured by extracting the fluorine-based liquid material by distillation or the like when the boiling point of the solvent is significantly different from the boiling point of the fluorine-based liquid material. As a result, the volume ratio of the fluorine-based liquid material to the total volume of the cathode active material layer 12 measured in advance is calculated. Further, the total solid content of the cathode active material layer 12 as 100% by mass, the content of the cathode active material is 40% by mass or more, 50% by mass or more, 60% by mass or more or 70% by mass or more it may be. The total solid content of the cathode active material layer 12 may be 100% by mass, and the content of the cathode active material may be less than 100% by mass, 95% by mass or less, or 90% by mass or less. Further, the content of the sulfide solid electrolyte may be more than 0% by mass, 5% by mass or more, or 10% by mass or more, with the total solid content of the cathode active material layer 12 being 100% by mass. The total solid content of the cathode active material layer 12 as 100% by mass, the content of the sulfide solid electrolyte, 60% by mass or less, 50% by mass or less, 40% by mass or less or 30% by mass or less it may be. Alternatively, the total amount of the cathode active material layer 12 may be 100% by volume, and the total amount of the cathode active material, the sulfide solid electrolyte, the fluorine-based liquid material, and optionally other electrolytes, the conductive auxiliary agent, and the binder may be 85% by volume or more, 90% by volume or more, or 95% by volume or more. The remainder may be voids or other components. The shape of the cathode active material layer 12 is not particularly limited. For example, the shape of the cathode active material layer 12 may be a sheet shape having a substantially flat surface. The thickness of the cathode active material layer 12 is not particularly limited. The thickness of the cathode active material layer 12 may be, for example, 0.1 μm or more, 1 μm or more, or 10 μm or more. The thickness of the cathode active material layers 12 may be, for example, 2 mm or less, 1 mm or less, or 500 μm or less.

### 1.1.1 Cathode Active Material

The cathode active material may be at least one selected from, for example, a Li compound, elemental sulfur, and sulfur compound. In particular, when the cathode active material contains a Li compound, it is easy to obtain higher efficacy. Only one cathode active material may be used alone. In addition, two or more types of cathode active materials may be used in combination. In one embodiment, the cathode active material may be a Li containing oxide. Li comprising oxide may comprise at least one element M, Li and O. The element M may be, for example, at least one selected from Mn, Ni, Co, Al, Mg, Ca, Sc, V, Cr, Cu, Zn, Ga, Ge, Y, Zr, Sn, Sb, W, Pb, Bi, Fe, and Ti. The element M may be, for example, at least one selected from the group consisting of Mn, Ni, Co, Al, Fe and Ti. More specifically, Li containing oxide may be at least one of the types selected from lithium cobalt oxide, lithium nickelate, lithium manganate, lithium nickel-cobalt oxide, lithium nickel-manganate, lithium cobalt manganate, lithium nickel cobalt manganate (Li_{1±α}NₓCo_{y}Mn_{z}O_{2±δ} (e.g., 0<x<1, 0<y<1, 0<z<1, x+y+z=1)), spinel-based lithium compounds (different kind element substituent Li—Mn spinel of a composition represented by Li₁₊ₓMn_{2-x-y}M_{y}O₄(M is one or more chosen from Al, Mg, Co, Fe, Ni and Zn) etc.), nickel cobalt aluminum acid lithium (e.g., Li_{1±α}NiₚCo_{q}AlᵣO_{2±δ} (e.g., p+q+r=1)), lithium titanate, metal lithium phosphate (LiMPO₄ etc., M may be at least one type selected from Fe, Mn, Co and Ni) or the like. In particular, when Li containing oxide as the cathode active material contains at least one of Mn, Ni and Co as a constituent element, higher performance is more likely to be obtained. Alternatively, even when the cathode active material contains at least one of Ni, Co and Al as a constituent element, higher performance is easily obtained. The shape of the cathode active material is not particularly limited, and may be, for example, particulate. The cathode active material particles may be solid particles, hollow particles, or particles having voids. The cathode active material particles may be primary particles or secondary particles each of which includes multiple primary particles that are aggregated. The mean particle diameter (D50) of the cathode active material particles may be, for example, 1 nm or more and 500 m or less. The lower limit may be greater than or equal to 5 nm or greater than or equal to 10 nm. The upper limit may be 100 m or less, 50 m or less, or 30 m or less. In the present application, the mean particle diameter D50 is the particle diameter (median diameter) at an integrated value of 50% in the volume-based particle size distribution determined by the laser diffraction/scattering method.

A protective layer containing an ion-conductive oxide may be formed on the surface of the cathode active material. As a result, the reaction or the like between the cathode active material and the sulfide solid electrolyte is more easily suppressed. As an ion-conducting oxide, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, etc. The ion conductive oxide may be one in which a part of the elements is replaced by a doping element such as P or B. The coverage ratio (area ratio) of the protective layer to the surface of the cathode active material may be, for example, 70% or more, 80% or more, or 90% or more. The thickness of the protective layer may be, for example, 0.1 nm or more or 1 nm or more, or may be 100 nm or less or 20 nm or less.

### 1.1.2 Sulfide Solid Electrolyte

As the sulfide solid electrolyte, any one known as a solid electrolyte having lithium ion conductivity can be employed. The sulfide solid electrolyte may be a glass-based sulfide solid electrolyte (sulfide glass), a glass-ceramic-based sulfide solid electrolyte, or a crystal-based sulfide solid electrolyte. When the sulfide solid electrolyte has a crystalline phase, examples of the crystalline phase include a Thio-LISICON crystalline phase, a LGPS crystalline phase, and an argyrodite crystalline phase. The sulfide solid electrolyte may contain, for example, a Li element, an X element (X is at least one of P, As, Sb, Si, Ge, Sn, B, and Al, Ga, In), and an S element. In particular, the constituent elements including Li, P, and S have higher performance. The sulfide solid electrolyte may further contain at least one of an O element and a halogen element. In particular, the constituent elements including Li, P, S, and a halogen element have higher performance. Examples of the sulfide solid electrolyte include, but are not limited to, xLi₂S·(100−x)P₂S₅ (70≤x≤80), yLiI·zLiBr·(100−y−z)(xLi₂S·(1−x)P₂S₅)(0.7≤x≤0.8, 0≤y≤30, and 0≤z≤30). Alternatively, the sulfide solid electrolyte may have a composition represented by the general formula: Li₄₋ₓGe₁₋ₓPₓS₄ (0<x<1). In the above formulae, at least a portion of Ge may be substituted with at least one of Sb, Si, Sn, B, Al, Ga, In, Ti, Zr, V, and Nb. In the above formulae, at least a part of P may be substituted with at least one of Sb, Si, Sn, B, Al, Ga, In, Ti, Zr, V, and Nb. In the above formulae, a part of Li may be substituted with at least one of Na, K, Mg, Ca, and Zn. In the above formulae, a part of S may be substituted with a halogen (at least one of F, Cl, Br, and I). Alternatively, the sulfide solid electrolyte may have a composition represented by Li₇₋ₐPS₆₋ₐXₐ. X is at least one of Cl, Br and I, and a is equal to or greater than 0 and equal to or less than 2. A may be 0 or greater than 0. When a is greater than 0, a may be greater than or equal to 0.1, greater than or equal to 0.5, or greater than or equal to 1. In addition, a may be 1.8 or less, or 1.5 or less. The shape of the sulfide solid electrolyte is not particularly limited. For example, the shape of the sulfide solid electrolyte may be particulate. Only one sulfide solid electrolyte may be used alone, or two or more sulfide solid electrolytes may be used in combination.

### 1.1.3 Fluorine-Based Liquid Material

The fluorine-based liquid material is a liquid material containing fluorine as a constituent element. According to the findings of the present inventors, in the cathode active material layer 12, a fluorine-based liquid material is interposed at the interface between the cathode active material and the sulfide solid electrolyte. That is, direct contact between the cathode active material and the sulfide solid electrolyte is suppressed by the fluorine-based liquid material. This makes it difficult for the sulfide solid electrolyte to be exposed to a high potential even when the cathode potential becomes a high potential. As a result, decomposition of the sulfide solid electrolyte is suppressed. As a result, even when the cathode potential reaches a high potential, the increase in resistance of the secondary battery 10 is reduced. Further, the fluorine-based liquid material has low reactivity to other battery materials. Therefore, even if the cathode active material layer 12 contains a fluorine-based liquid material, a cathode active material, a sulfide solid electrolyte, or the like may stably exist. The fluorine-based liquid material may be, for example, an organic fluorine compound in which fluorine is bonded to a carbon chain. For example, the cathode active material layer 12 may contain perfluoropolyether as a fluorine-based liquid material. The perfluoropolyether as the fluorine-based liquid material has an ether bond, and therefore, it is considered that the perfluoropolyether has high affinity for the surface of other battery materials. For example, it is contemplated that the perfluoropolyether may suitably be present due to voids between the active material, voids between the sulfide solid electrolyte material, voids between the active material and the sulfide solid electrolyte material, and the like. This further suppresses direct contact between the cathode active material and the sulfide solid electrolyte. Further, as described above, the perfluoropolyether has low reactivity to other battery materials.

The cathode active material layer 12 may contain a perfluoropolyether represented by the following formula (1) as a fluorine-based liquid material.

E₁-Rf₁-R^{F}—O—Rf₂-E₂ (1)

In the formula (1), Rf₁ and Rf₂ are each independently a C1-16 divalent alkylene group which may be substituted by one or more fluorine atoms. E₁ and E₂ are each independently consisted of a single-valence group selected from a group consisting of fluorine group, hydrogen group, hydroxyl group, aldehyde group, carbonic acid group, C1-10 alkylester group, amide group that may have one or more substituents, amino group that may have one or more substituents. R^{F} is a divalent fluoropolyether group.

In the above formula (1), Rf₁ and Rf₂ are each independently a C1-16 divalent alkylene group which may be substituted by one or more fluorine atoms. In one embodiment, the “C1-16 divalent alkylene group” in C1-16 divalent alkylene group optionally substituted by one or more fluorine atoms may be linear or branched. Preferably, this “C1-16 divalent alkylene group” may be a straight or branched C1-6 alkylalkylene group, in particular a C1-3 alkylene group. More preferably, this “C1-16 divalent alkylene group” may be a linear C1-6 alkylene group, in particular a C1-3 alkylene group. In one embodiment, the “C1-16 divalent alkylene” in C1-16 divalent alkylene group optionally substituted by one or more fluorine atoms may be linear or branched. Preferably, this “C1-16 divalent alkylene” is a straight or branched C1-6 fluoroalkylene group, in particular a C1-3 fluoroalkylene group. Specifically, the “divalent alkylene of C1-16” may be —CF₂CH₂— and —CF₂CF₂CH₂—. More preferably, the “C1-16 divalent alkylene” is a linear C1-6 perfluoroalkylene group, particularly a C1-3 perfluoroalkylene group. Specifically, the “divalent alkylene of C1-16” may be a group selected from the group consisting of —CF₂—, —CF₂CF₂—, and —CF₂CF₂CF₂—.

In the above formula (1), E₁ and E₂ are each independently fluorine group, hydrogen group, hydroxyl group, aldehyde group, carbonic acid group, C1-10 alkylester group, may have one or more substituents amide group, an amino group may have one or more substituents, consisting of a group consisting of a single-valence group. As described above, the perfluoropolyether has low reactivity to a sulfide solid electrolyte described later. Therefore, even when the perfluoropolyether and the sulfide solid electrolyte come into contact with each other, deterioration of ion and deterioration of the sulfide solid electrolyte hardly occur. In particular, when the perfluoropolyether has a non-polar group as a terminal group, the reaction between the perfluoropolyether and the sulfide solid electrolyte is further suppressed, and a higher effect can be expected. In this regard, the E₁ and the E₂ are each independently preferably a fluorine group. In one aspect, the E₁-Rf₁ and E₂-Rf₂ may each independently be a group selected from the group consisting of —CF₃, —CF₂CF₃, and —CF₂CF₂CF₃.

In the above formula (1), R^{F} is each independently a divalent fluoropolyether group at each occurrence. R^{F} is preferably a group represented by the formula (2).

—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}— (2)

In formula (2): R^{Fa} is each independently a hydrogen atom, a fluorine atom or a chlorine atom at each occurrence; a, b, c, d, e and f are each independently an integer from 0 to 200; the sum of a, b, c, d, e and f is greater than or equal to 1; and the order of occurrence of each repeating unit in parentheses with a, b, c, d, e or f is arbitrary in the formula. However, when all R^{Fa} are hydrogen atoms or chlorine atoms, at least one of a, b, c, e, and f is 1 or more. R^{Fa} is preferably a hydrogen atom or a fluorine atom, more preferably a fluorine atom. Each of a, b, c, d, e and f may preferably independently be an integer from 0 to 100. The sum of a, b, c, d, e and f is preferably 5 or more, and more preferably 10 or more. For example, the sum of a, b, c, d, e, and f may be 15 or more, or 20 or more. The sum of a, b, c, d, e and f is preferably equal to or less than 200, more preferably equal to or less than 100, and even more preferably equal to or less than 60. The sum of a, b, c, d, e, and f may be, for example, 50 or less or 30 or less.

These repeating units may be linear or branched. In R^{F}, the ratio of d to f (hereinafter referred to as “d/f ratio”) may be 0.5 to 4, preferably 0.6 to 3, more preferably 0.7 to 2, and even more preferably 0.8 to 1.4. When d/f ratio is 4 or less, lubricity and chemical stability are further improved. The smaller d/f fraction, the better the lubricity. On the other hand, by setting d/f ratio to 0.5 or more, the compound can be more stable. The greater d/f fraction, the better the stabilities of the fluoropolyether construction. In this case, the value of f is preferably 0.8 or more. In the above, the number average molecular weight of the R^{F} moiety is not particularly limited, but is, for example, 500 to 30,000, preferably 1500 to 30,000, and more preferably 2000 to 10,000. In the present application, the number-average molecular weight of R^{F} is measured by ¹⁹F-NMR.

### 1.1.4 Other Ingredients

The other electrolyte that may be included in the cathode active material layer 12 may be a solid electrolyte, a liquid electrolyte, or a combination thereof. The solid electrolyte may be an inorganic solid electrolyte or an organic polymer electrolyte. Examples of the inorganic solid electrolyte other than the sulfide solid electrolyte include an oxide solid electrolyte, a halide solid electrolyte, and a complex hydride solid electrolyte. The electrolytic solution may be, for example, a solution obtained by dissolving a lithium salt in a carbonate-based solvent at a predetermined concentration. Examples of the carbonate-based solvents include fluoroethylene carbonate (FEC), ethylene carbonate (EC), and dimethyl carbonate (DMC). Examples of the lithium salt include lithium amide salts such as LiTFSI and LiFSI, and LiPF₆.

Examples of the conductive auxiliary agent that can be included in the cathode active material layers 12 include carbon materials such as vapor-phase carbon fibers (VGCF), acetylene black (AB), Ketjen black (KB), carbon nanotubes (CNT), and carbon nanofibers (CNF). The conductive aid may be a metallic material such as nickel, aluminum, stainless steel, etc. The conductive aid may be, for example, in the form of particles or fibers, and its size is not particularly limited. Only one type of conductive aid may be used alone, or two or more types may be used in combination.

Examples of the binder that can be included in the cathode active material layer 12 include a butadiene rubber (BR) binder, a butylene rubber (JIR) binder, an acrylate butadiene rubber (ABR) binder, a styrene butadiene rubber (SBR) binder, a polyvinylidene fluoride (PVdF) binder, a polytetrafluoroethylene (PTFE) binder, and a polyimide (PI) binder. Only one type of binder may be used alone, or two or more types may be used in combination.

### 1.2 Electrolyte Layer

The electrolyte layer 13 is disposed between the cathode active material layer 12 and the anode active material layer 14. The electrolyte layer 13 may function as a separator. The electrolyte layer 13 includes at least an electrolyte, and may optionally include a binder or the like. For example, the electrolyte layer 13 may include the above-described sulfide solid electrolyte. The electrolyte layer 13 may further contain other components such as a dispersant and the above-described fluorine-based liquid material. The content of each component in the electrolyte layer 13 is not particularly limited, and may be appropriately determined according to the desired battery performance. The shape of the electrolyte layer 13 is not particularly limited. The shape of the electrolyte layer 13 may be, for example, a sheet shape having a substantially flat surface. The thickness of the electrolyte layer 13 is not particularly limited. The thickness of the electrolyte layers 13 may be, for example, 0.1 m or more or 1 m or more, and may be 2 mm or less or 1 mm or less.

### 1.3 Anode Active Material Layer

The anode active material layer 14 includes at least an anode active material, and may optionally include an electrolyte, a conductive auxiliary agent, a binder, and the like. The anode active material layer 14 may contain various additives. As the anode active material, an appropriate one may be adopted from known active materials such as a silicon-based active material, a carbon-based active material, and an oxide-based active material. The content of each component in the anode active material layer 14 may be appropriately determined according to the desired battery performance. For example, the entire solid content of the anode active material layer 14 as 100% by mass, the content of the anode active material is 40% by mass or more, 50% by mass or more, 60% by mass or more or 70% by mass it may be. The total solid content of the anode active material layer 14 may be 100% by mass or less, 95% by mass or less, or 90% by mass or less, based on 100% by mass. The shape of the anode active material layer is not particularly limited. The shape of the anode active material layer may be, for example, a sheet-like anode active material layer having a substantially flat surface. The thickness of the anode active material layer 14 is not particularly limited. For example, the thickness of the anode active material layer 14 may be 0.1 m or more, 1 m or more, or 10 m or more. The thickness of the anode active material layers 14 may be 2 mm or less, 1 mm or less, or 500 m or less.

### 1.4 Other Configurations

Each of the positive electrode current collector 11 and the negative electrode current collector 15 of the secondary battery 10 may be a general current collector of a secondary battery. In the secondary battery 10, each of the above-described configurations may be accommodated in an exterior body. As the exterior body, any known exterior body of the battery can be adopted. Further, the plurality of secondary batteries 10 may be electrically connected to each other, and may be arbitrarily overlapped to form a battery pack. In this case, the assembled battery may be housed inside a known battery case. The secondary battery 10 may have an obvious configuration such as a necessary terminal. As the shape of the secondary battery 10, for example, coin-type, laminate-type, cylindrical, and square-type, and the like. The secondary battery 10 can be manufactured by, for example, a method disclosed in JP 2019-125510 A or the like, except that the cathode active material layer 12 includes a fluorine-based liquid material together with the cathode active material and the sulfide solid electrolyte. That is, each layer constituting the secondary battery 10 may be manufactured by wet molding, dry molding, or the like.

### 2. Control Unit

As illustrated in FIG. 1, the secondary battery system 100 includes a control unit 20. The control unit 20 is not particularly limited as long as it can control charging and discharging of the secondary battery 10. The control unit 20 has a known configuration necessary for controlling charging and discharging of the secondary battery 10. The control unit 20 may include, for example, a CPU, RAM, ROM or the like.

The control unit 20 controls the charging of the secondary battery 10 such that the cathode potential at the charging termination potential of the secondary battery 10 is equal to or higher than 4.3 V (vs. Li/Li+). In the conventional secondary battery, when the charge is performed until the cathode potential becomes higher than or equal to 4.3 V (vs. Li/Li+), decomposition of the sulfide solid electrolyte or the like occurs, and the resistivity of the secondary battery tends to be increased. On the other hand, in the secondary battery system 100 according to the present embodiment, as described above, the cathode active material layer 12 of the secondary battery 10 includes a fluorine-based liquid material together with the cathode active material and the sulfide solid electrolyte. Therefore, even when the cathode potential of the secondary battery 10 becomes higher than or equal to 4.3 V (vs. Li/Li+), decomposition or the like of the sulfide solid electrolyte is easily suppressed, and the resistivity of the secondary battery 10 is easily increased.

The control unit 20 may control the charging of the secondary battery 10 such that the cathode potential at the charging termination potential of the secondary battery 10 is equal to or greater than 4.4 V (vs. Li/Li+), 4.5 V (vs. Li/Li+), or 4.6 V (vs. Li/Li+), or 4.7 V (vs. Li/Li+). The upper limit of the charge termination potential is not particularly limited. For example, the control unit 20 may control the charging of the secondary battery 10 such that the cathode potential at the charging termination potential of the secondary battery 10 is equal to or higher than 4.3 V (vs. Li/Li+) and equal to or lower than 5.0 V (vs. Li/Li+). As described above, the control unit 20 controls charging of the secondary battery 10. However, the control unit 20 may control discharging in addition to charging of the secondary battery 10. The discharge termination potential of the secondary battery 10 may be appropriately determined in accordance with the performance of the secondary battery 10 and the like.

Hereinafter, the technique of the present disclosure will be described in more detail with reference to examples. However, the technique of the present disclosure is not limited to the following examples.

### 1. Preparation of Positive Electrode

### 1.1 Examples 1 to 4 and Comparative Examples 7 and 8

In an organic solvent, a binder (PVdF), a conductive aid (VGCF), a sulfide solid electrolyte (LiI—LiBr—Li₂S—P₂S₅), a cathode active material (LiNi_{1/3}Co_{1/3}Mn_{1/3}O₂), and a perfluoropolyether (PFPE, Fujifilm Wako Pure Chemical Industries, Ltd. perfluoro (polyoxypropylene ethyl ether) 2700) were kneaded using an ultrasonic homogenizer. Thus, a positive electrode mixture slurry was obtained. The resulting positive electrode mixture slurry was coated on an Al foil and dried. In this way, a positive electrode for pressing provided with cathode active material layers on an Al foil as a positive electrode current collector was obtained. Here, the volume ratio of PFPE in the mixture material was set to be 8% by volume.

### 1.2 Comparative Example 6 from Comparative Example 1

A positive electrode for pressing was obtained in the same manner as in Example 1 to Example 4 and Comparative Examples 7 and 8, except that no PFPE was added to the positive electrode mixture.

### 2. Preparation of Electrolyte Layer

A binder (PVdF) and a sulfide solid electrolyte (LiI—LiBr—Li₂S—P₂S₅) were added to the organic solvents and kneaded using an ultrasonic homogenizer. Thus, an electrolyte mixture slurry was obtained. The resulting electrolyte mixture slurry was coated on an Al foil and dried. In this way, the solid-state electrolyte layers were formed on Al foil as a base material.

### 3. Preparation of Batteries

The positive electrode for pressing was cut into strips. The cut cathode active material layer and the solid electrolyte layer were superposed on each other and rolled at 165° C. under 50 kN/cm pressure. Al foil as a base material was peeled off. Thus, the solid electrolyte layer was transferred to the surface of the cathode active material layer. A Li foil punched out on the φ13.00 mm was superimposed on the solid-state electrolyte layers. In this way, a laminate having an Al foil/cathode active material layer/solid electrolyte layer/Li foil structure was obtained. A current extraction tab was attached to the laminate and sealed in an aluminum laminate using a vacuum laminator sealer. Thus, a battery for evaluation was prepared.

### 4. Battery Performance Evaluation

The manufactured battery was charged to the charge end voltage (upper limit voltage), and a trickle test (held at each upper limit voltage for 1 week) was performed at the upper limit voltage. In this way, the resistance values before and after the trickle test were measured. Specifically, the voltages of the cells before and after the trickle test were adjusted to 3.7 V and discharged at 5 C rates. Resistance values of the respective batteries were calculated from the voltage drop from discharge to 5 seconds. The resistance value after the trickle test with respect to the resistance value before the trickle test was measured, and this was taken as the resistance increase rate. The results are shown in Table 1 below. In Table 1 below, the resistivity increase rate for Comparative Example 1 is set as a reference (100%), and the resistivity increase rates for Comparative Example 2 to Comparative Example 8 and Examples 1 to 4 are relative to each other.

TABLE 1

| | | Upper Limit | | Remarks (Comparison |
|---|---|---|---|---|
| | Pres- | Voltage | | With Resistance |
| | ence | (Cathode | Resistance | Increase Rate of |
| | of | Potential) [V | Increase | Battery Under the |
| | PFPE | (vs. Li/Li⁺)] | [%] | Same Condition) |
| Comparative | None | 3.7 | 100 | — |
| Example 1 | | | | |
| Comparative | None | 3.9 | 100 | — |
| Example 2 | | | | |
| Comparative | None | 4.3 | 102 | — |
| Example 3 | | | | |
| Comparative | None | 4.5 | 135 | — |
| Example 4 | | | | |
| Comparative | None | 4.7 | 155 | — |
| Example 5 | | | | |
| Comparative | None | 5.0 | 223 | — |
| Example 6 | | | | |
| Comparative | Y | 3.7 | 100 | Without changing from |
| Example 7 | | | | Comparative Example 1 |
| Comparative | Y | 3.9 | 100 | Without changing from |
| Example 8 | | | | Comparative Example 2 |
| Example 1 | Y | 4.3 | 101 | −1% relative to |
| | | | | Comparative Example 3 |
| Example 2 | Y | 4.5 | 118 | −17% of Comparative |
| | | | | Example 4 |
| Example 3 | Y | 4.7 | 137 | −18% relative to |
| | | | | Comparative Example 5 |
| Example 4 | Y | 5.0 | 185 | −38% of Comparative |
| | | | | Example 6 |

As is apparent from the results shown in Table 1, when the cathode active material layer contains a sulfide solid electrolyte together with the cathode active material and does not contain PFPE (Comparative Examples 1 to 6), when the cathode potential in the trickle test is less than 4.3 V (vs. Li/Li+), the resistivity of the cell does not increase even after the trickle test (Comparative Examples 1 and 2). However, when the cathode potential in the trickle test is equal to or higher than 4.3 V (vs. Li/Li+), it is found that the resistivity of the cell is increased after the trickle test (Comparative Example 3 to Comparative Example 6). In Comparative Example 3 to Comparative Example 6, it is considered that the sulfide solid electrolyte was decomposed when the sulfide solid electrolyte was exposed to a high potential. As a result, it is considered that the resistance of the battery increased.

On the other hand, when the cathode active material layer contains a sulfide solid electrolyte together with the cathode active material and PFPE (Comparative Examples 7 and 8, Examples 1 to 4), the cathode potential in the trickle test is less than 4.3 V (vs. Li/Li+), and thus the cathode active material layer does not have a beneficial effect due to the inclusion of PFPE (Comparative Examples 1 and 2 and Comparative Examples 7 and 8). On the other hand, when the cathode potential in the trickle test is equal to or higher than 4.3 V (vs. Li/Li+), it is found that the increased resistivity of the batteries can be suppressed by including PFPE (comparison between Comparative Example 3 and Comparative Example 6 and Examples 1 to 4). In Examples 1 to 4, it is considered that direct contacting between the cathode active material and the sulfide solid electrolyte was suppressed by PFPE, and even when the cathode potential became a high potential, the sulfide solid electrolyte was hardly exposed to the high potential, and decomposition of the sulfide solid electrolyte was suppressed. As a result, it is considered that the increase in the resistance of the battery was reduced even when the cathode potential became high.

### 5. Supplement

In the above embodiment, a particular PFPE is exemplified as the fluorine-based liquid material. However, the type of the fluorine-based liquid material is not limited to PFPE. Further, in the above embodiment, a particular battery material (NCM as a cathode active material, LiI—LiBr—Li₂S—P₂S₅ as a sulfide solid electrolyte, PVdF as a binder, VGCF as a conductive aid, and Li foil as an anode active material) was used as an example. However, even when a battery material other than these is used, it is considered that the above-described effects can be exhibited by using a fluorine-based liquid material in combination with a cathode active material and a sulfide solid electrolyte in the cathode active material layer.

### 6. Summary

From the above results, it can be said that the increase in the resistance of the secondary battery in the high potential region can be reduced according to the secondary battery system having the following configuration.
(1) The secondary battery system includes a secondary battery and a control unit.
(2) The secondary battery includes a cathode active material layer, an electrolyte layer, and an anode active material layer.
(3) The cathode active material layer includes a cathode active material, a sulfide solid electrolyte, and a fluorine-based liquid material.
(4) The control unit controls charging of the secondary battery such that a cathode potential at a charging termination potential of the secondary battery is equal to or greater than 4.3 V (vs. Li/Li+).

What is claimed is:

1. A secondary battery system comprising:
a secondary battery; and
a control unit, wherein
the secondary battery includes a cathode active material layer, an electrolyte layer, and an anode active material layer,
the cathode active material layer includes a cathode active material, a sulfide solid electrolyte, and a fluorine-based liquid material, and
the control unit is configured to control charging of the secondary battery to cause a cathode potential at a charging end potential of the secondary battery to be equal to or higher than 4.3 V (vs. Li/Li+).

2. The secondary battery system according to claim 1, wherein the cathode active material layer includes perfluoropolyether as the fluorine-based liquid material.

3. The secondary battery system according to claim 1, wherein the cathode active material is a Li containing oxide.

4. The secondary battery system according to claim 3, wherein the Li containing oxide includes at least one kind of transition metal element among Mn, Ni, and Co as a constituent element.
